(19) United States
(12) Patent Application Publication
(10) Pub. No.: US 2006/0199408 A1
(43) Pub. Date: Sep. 7, 2006

(54) Modular electrical connection unit and method of forming an electrical connector

(76) Inventors: Mark A. Hoisington, Austin, TX (US); Brian C. Inberg, Cedar Park, TX (US); Charles Mitchell, Austin, TX (US); Walter R. Romanko, Austin, TX (US); Richard D. Twigg, Austin, TX (US)

Correspondence Address: 3M INNOVATIVE PROPERTIES COMPANY, PO BOX 33427, ST. PAUL, MN, 55133-3427, US

(21) Appl. No.: 11/072,133

(22) Filed: Mar. 4, 2005

(51) Int. Cl. H01R 13/648

(52) U.S. Cl. 439/108

(57) ABSTRACT

A method of forming an electrical connector includes electrically and mechanically connecting at least two modules together and forming a generally continuous, electrically insulative coating over at least part of the connected modules.

### BACKGROUND

The present invention relates to an electrical connector and a method of forming an electrical connector. More specifically, the present invention relates to an electrical connection unit that may be mated with one or more electrical connection units to form an electrical connector, and a method of manufacturing an electrical connector using the electrical connection units.

Electrical connectors are often used for connecting cable conductors together, such as during the distribution of electrical power. For example, an electrical connector may be used as an environmentally sealed branch connector when electrical power is distributed from a power generation plant to consumers of electrical power. A cable conductor (“cable”) may be formed of a conductive core (typically copper or aluminum) and may be surrounded by one or more layers of insulating material. The electrical connector may have one or more openings for receiving an electrical cable. An electrical connector may be an insulation-piercing connector (“IPC”), which incorporates insulation-piercing elements (also known as “teeth”) in an opening in order to create an electrical connection between the electrical connector and the insulated cable.

An electrical connector may have one or more connection ports for receiving a cable, such as a secondary power cable. Typically, it is preferred that the electrical connector have more than one port (a “multiport” bus bar) because after a cable of a power distribution system is installed, it may be necessary to install or to make provision for subsequent installation of another cable, such as for creating another branch in the power distribution scheme. The number of ports an electrical connector has will depend upon the number of cables it is intended to connect.

Given the variety of applications and needs of end users, manufacturers may be required to supply electrical connectors in a variety of port configurations. For example, a manufacturer may offer an electrical connector in four-port, five-port, six-port, seven-port, or eight-port configurations. However, providing so many different port configurations may cause manufacturing inefficiencies. For example, more than one mold may be required in order to accommodate the manufacture of different port configurations, or if a family of molds is used, the molding process may be complex. Manufacturing different port configurations may also require multiple types of assembly equipment. Similarly, because an electrical connector is typically purchased having a predetermined and fixed number of ports, an end user may be required to accurately anticipate its future connection requirements at the time it installs the electrical connector.

### BRIEF SUMMARY

In a first aspect, the present invention is a method of forming an electrical connector. The method includes electrically and mechanically connecting a first module to a second module and forming a generally continuous, electrically insulative coating over at least part of the connected first and second module.

In a second aspect, the present invention is a method of expanding an electrical connector having an electrically insulative outer coating material thereon. The method includes removing a section of the coating material which covers a first mating portion of the electrical connector by separating the coating along a frangible perimeter extending around the first mating portion, electrically and mechanically connecting a second mating portion of an expansion module to the first mating portion of the electrical connector, and securing the expansion module to the electrical connector.

In a third aspect, the present invention is an electrical connector module including a body, a mating portion on the body, a zip strip positioned on the body around the mating portion, and an electrically insulative coating formed over the mating portion and the zip strip.

In a fourth aspect, the present invention is an electrical connector assembly including a first module, a second module connected to the first module, and an electrically insulative coating. The second module has a mating portion extending from a side opposing the first module. The electrically insulative coating formed over the connected first and second modules.

The above summary is not intended to describe each disclosed embodiment or every implementation of the present invention. The figures and the detailed description which follow more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1 is a perspective view of an electrical connector with a portion of its cover removed, and is used to show an exemplary structure for an electrical connector.

FIG. 2A is a perspective view of a two-port electrical connector module in accordance with the present invention, from the front and one side thereof.

FIG. 2B is a rotated perspective view of the module of FIG. 2A, showing the front and other side thereof.

FIG. 3A is a perspective view of a five-port electrical connector from the front and one side thereof.

FIG. 3B is a rear perspective view of the electrical connector of FIG. 3A, from the same side as FIG. 3A.

FIG. 4A is a rear perspective view, showing an exemplary embodiment of a securing mechanism that may be used between two electrical connector modules.

FIG. 4B is a rear perspective view showing two electrical connector modules after they have been electrically and mechanically connected.

FIG. 5A is a perspective view of an electrical connector module showing the rear and side view of an exemplary zip strip (prior to placing an insulative coating over the module).

FIG. 5B is a perspective view of the zip strip of FIG. 5A.

FIG. 5C is a sectional view as taken along lines A-A in FIG. 5A, but with an insulative coating on the module.

FIG. 5D is a sectional view as taken along lines A-A in FIG. 5A, but showing a second exemplary embodiment of a zip strip positioned around a mating portion on an electrical connector module (and with an insulative coating on the module).

While the above-identified figures set forth one or more embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

The present invention is an electrical connector including at least two electrically and mechanically connected modular electrical connection units (“modules”) and an electrically insulative coating (“overcoat” or “coating”) formed over at least part of the connected modules, and a method of forming the same. A module in accordance with the present invention may include a “zip strip” which enables an end user to remove a section of the overcoat which is formed over a mating portion in order to expand upon a preassembled electrical connector. A “preassembled” electrical connector is an electrical connector that has been assembled by a manufacturer and is ready to use as is, or may be expanded upon by an end-user. A modular manufacturing process may help create manufacturing efficiencies. For example, fewer molds may be required and there may be a reduction in the different types of assembly equipment required for the manufacture of various port configurations.

A module in accordance with the present invention is an individual electrical connection unit having the ability to be connected to a second module to create a plurality of electrical connector configurations. For example, the present invention may be used with the modules described in U.S. patent application Ser. Nos. 10/911,858, and 10/911,802, both entitled “MODULAR ELECTRICAL CONNECTOR AND METHOD OF USING” and filed on Aug. 5, 2004, and both incorporated by reference herein. In the present invention, an electrical connector is formed by connecting two or more individual modules to create an electrical and mechanical connection between the modules. The modules may be connected by connecting complimentary mating portions on each module. It is preferred that each module contains at least one port for receiving a cable. The modules may or may not be the same size, and may or may not have the same number of ports. The present invention allows an end user to add one or more modules to the preassembled electrical connector in the field (after the modules have left the manufacturer's hands), thereby expanding the electrical connector by including one or more additional ports.

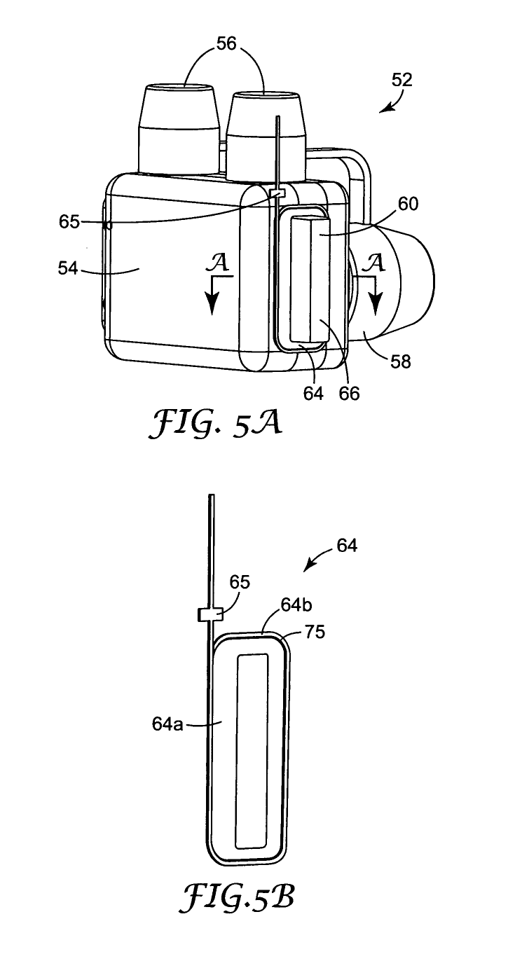

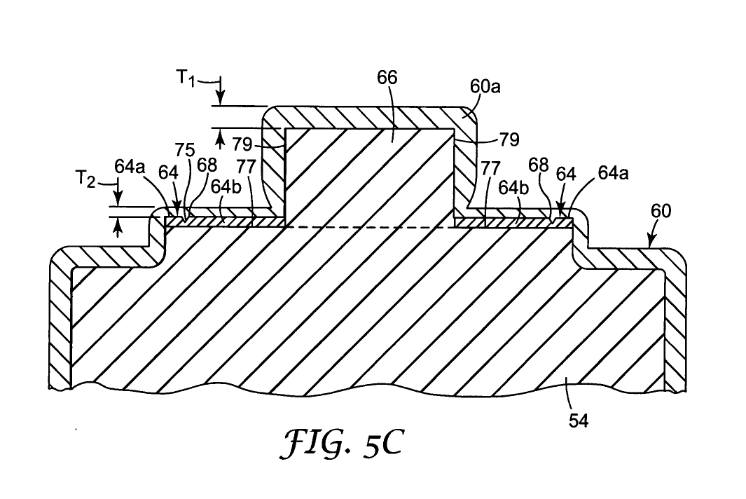

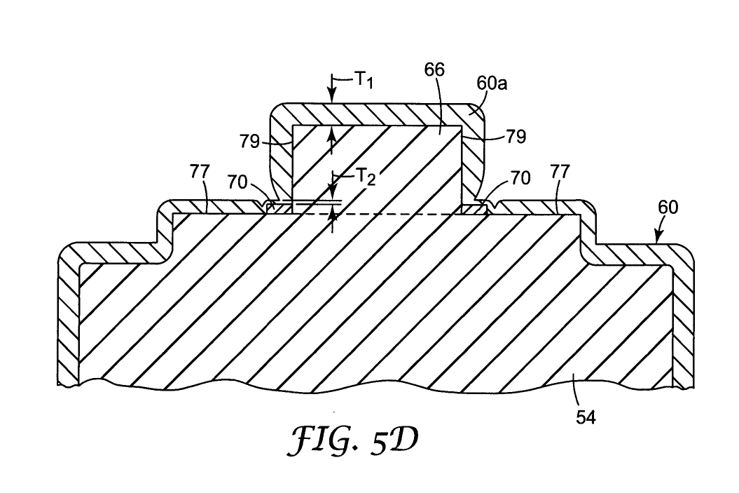

The present invention is a method of forming an electrical connector. The method includes electrically and mechanically connecting and securing a first module to a second module, such as by connecting complimentary mating portions on the modules. One or more modules may be added onto the first and/or second modules to further expand and increase the number of ports on the electrical connector. If an unmated mating portion remains after an electrical connector is formed, a zip strip (e.g., zip strip 64 of FIGS. 5A and 5B) may be positioned around the unmated mating portion prior to forming the electrically insulative coating over the electrical connector. The finished electrical connector may then be coated with an electrically insulative material. At a later time, an end user may add one or more modules onto a module that is part of a finished electrical connector by connecting complimentary mating portions of the modules. The end user may remove a section of the coating which is covering the mating portion by using the zip strip (which creates a frangible seam in the overcoat that preferably extends around a perimeter of the mating portion), thereby exposing the mating portion. Individual modules that have been coated with an electrically insulative material may also be provided to an end user, and the end user may connect two or more of these individual modules in the field.

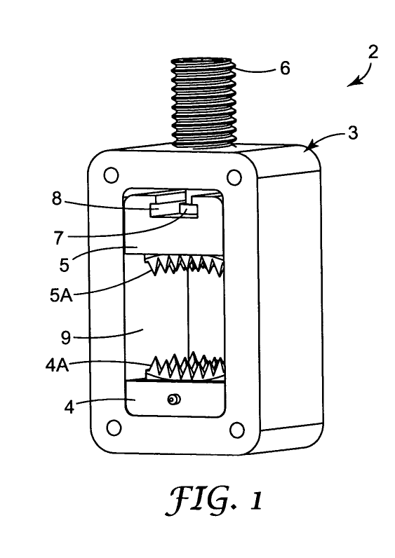

FIG. 1 is a perspective view of IPC 2, where a portion of outer housing 3 has been removed to show fixed jaw 4, moveable jaw 5, and bolt 6. IPC 2 is used to show a general IPC structure and is not intended to limit the scope of the invention in any way. Movable jaw 5 moves along a longitudinal axis of housing 3, and is actuated by a threaded bolt 6 extending through a threaded bore in housing 3. Bolt 6 and movable jaw 5 are operably joined by slidably inserting an enlarged round head 7 on bolt 6 into a T-shaped slot 8 in movable jaw 5. In this manner, bolt 6 may rotate along its longitudinal axis relative to movable jaw 5. As bolt 6 is turned and advanced into cavity 9, movable jaw 5 moves toward fixed jaw 4. A cable (not shown in FIG. 1) which is inserted between fixed jaw 4 and moveable jaw 5 is thus clamped in place with the aid of insulation piercing elements 4A and 5A on jaws 4 and 5, respectively. Insulation piercing elements 4A and 5A pierce an insulative layer on the cable in order to establish an electrical connection with the conductive core of the cable, while at the same time achieving a mechanical connection between the cable and IPC 10. Likewise, when bolt 6 is turned and retracted from the cavity 9, movable jaw 5 moves away from fixed jaw 4 and the grip therebetween loosens on the cable.

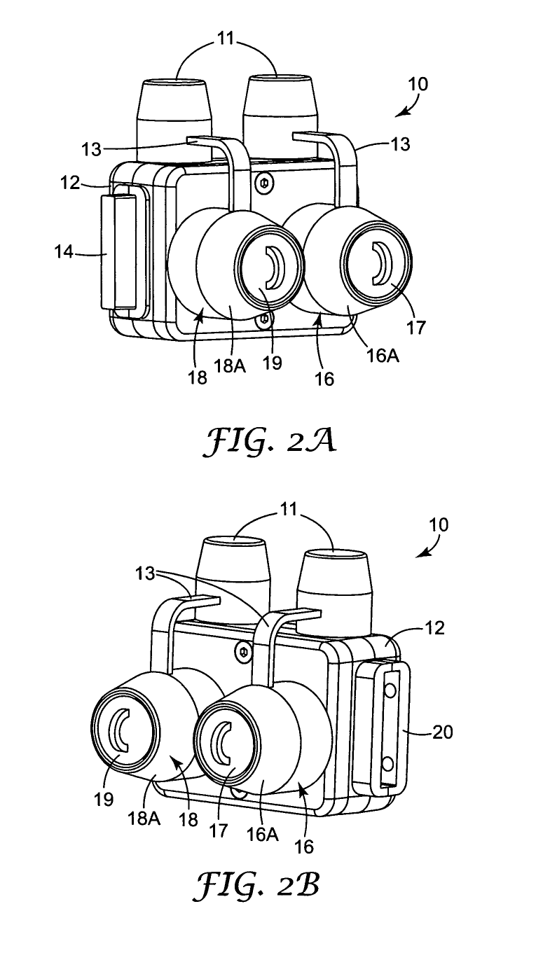

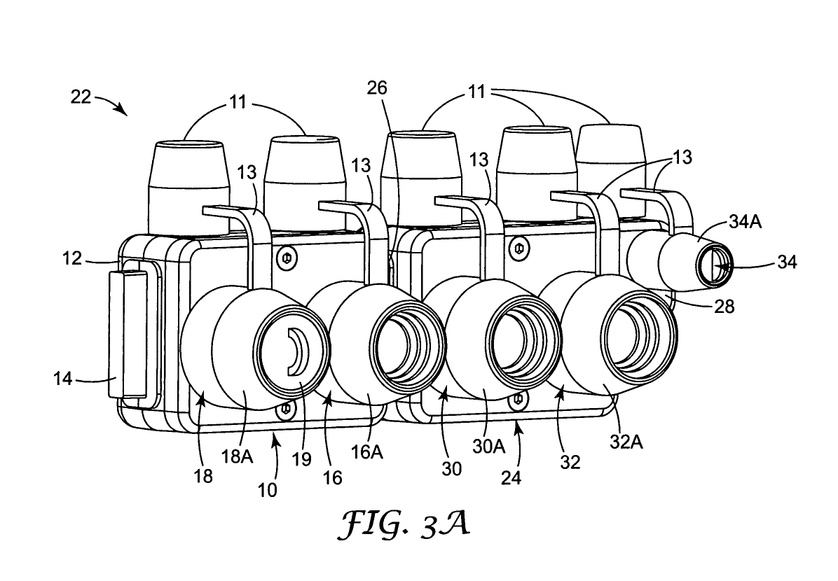

FIG. 2A is a perspective view of two-port module 10 in accordance with the present invention. Module 10 is an exemplary module and is not intended to limit the scope of this disclosure in any way. Those skilled in the art will realize that the present invention may be used in conjunction with other modular electrical connection units, such as the units described in U.S. patent application Ser. Nos. 10/911,858, and 10/911,802. Module 10 includes bolt covers 11, body 12, male mating portion 14, and ports 16 and 18 (which are covered with port seal 16A and 18A, respectively). Each bolt cover 11 is positioned over a bolt (e.g., bolt 6 of FIG. 1), which maybe used to move a clamping jaw (e.g., moveable jaw 5 of FIG. 1). When access to an underlying bolt is needed, the respective bolt cover 11 may be removed. Each bolt cover 11 is held onto module 10 by strap 13, where each strap 13 is connected to port seals 16A and 18A, respectively. Strap 13 may help prevent an end user from losing bolt covers 11 because even when bolt covers 11 are not covering the underlying bolts, bolt covers 11 will be connected to port 16 and 18. Each clamping jaw is accessible via a respective port 16 or 18 and has insulation-piercing elements (e.g. insulation piercing elements 4A and 5A of FIG. 1) on relatively moveable jaws (e.g., jaws 4 and 5 of FIG. 1) to establish a mechanical and electrical connection with a cable that is inserted into port 16 or port 18.

Body 12 may be formed of any electrically conductive material, such as aluminum, copper, brass, or blends thereof. Male mating portion 14 protrudes from a side of body 12. As discussed in reference to FIGS. 5A and 5B below, a zip strip may be positioned around male mating portion 14. One or more additional mating portions (male or female) may also extend off the same side of body 12 as male mating portion 14. Ports 16 and 18 are each configured to receive an electrical cable. Ports 16 and 18 may also be different sizes, where each port 16 and 18 is sized to receive a different sized cable. Body 12 may have any number of ports, but it is preferred that body 12 has at least one port. As shown in FIGS. 2A and 2B, each of ports 16 and 18 are covered with a seal 16A and 18A, respectively, where the seal is formed of an electrically insulating material, such as ethylene-propylene-diene monomer (EPDM) rubber. Ports seals 16A and 18A may be initially fitted with port seal plugs 17 and 19, respectively, which each mechanically engage with its respective port seal 16A and 18A and may be removed at any time and replaced by a cable, for example, in order to add a branch line to the power distribution system of the main cable. Port seal plugs 17 and 19 may be formed of rubbers such as EPDM or plastisol, or thermoplastic materials such as polypropylene or polyethylene.

If module 10 is to be used as an “expansion” module, and is distributed to an end user as an individual module rather than being preassembled in an electrical connector, it is preferred that at least part of module 10 be sealed by a generally continuous, electrically insulative coating in order to insulate module 10 and minimize the potential for water intrusion and other environmental intrusions. It is preferred that the coating be formed with a material that is substantially moisture-impervious. For example, EPDM rubber or vinyl plastisol may be used as the coating material.

One method of forming the coating includes preheating body 12 and the zip strip (if one is positioned around male mating portion 14) to about 350° F. and “dipping” body 12 and the zip strip into the coating material. The overcoat is then post-heated to about 350° F. Portions of body 12 which should not be covered with the coating may be masked off prior to forming the coating. Silicon is a preferred mask material if vinyl plastisol is used as the coating material because vinyl plastisol does not adhere to silicon. It may be preferred to mask off the bolts and/or ports 16 and 18. In a preferred method, body 12 is dipped such that ports 16 and 18 are not submerged in the overcoat material, and thus, it may not be necessary to mask off ports 16 and 18. The final thickness of the coating may be controlled by the temperature at which body 12 and the zip strip are preheated to, the dwell time during the dipping process, and the number of times body 12 and the zip strip are dipped into the protective material. Body 12 and the zip strip do not necessarily need to be “dipped” into the protective material, but any other method of coating may be used, including a molding method using a material such as EPDM.

FIG. 2B is a rotated perspective view of module 10, showing the front and other side thereof. Female mating portion 20 is disposed on a side of body 12 and is located on an opposing surface of body 12 from male mating portion 14. One or more additional mating portions (male or female) may also be on the same side of body 12 as female mating portion 20. It is not required that module 10 have both male mating portion 14 and female mating portion 20. For example, if module 10 is used as a base module from which an electrical connector is formed, it may be preferred to have only male mating portion 14 or only female mating portion 20.

As FIGS. 2A and 2B show, male mating portion 14 and female mating portion 20 are shaped to connect and “mate” together. Although male mating portion 14 and female mating portion 20 are on the same module 10, another module (not shown in FIGS. 2A or 2B) which is to be added to module 10 will have a mating portion that will correspond and electrically and mechanically connect with either male mating portion 14 or female mating portion 20. If a side of module 10 has more than one mating portion, it is preferred that the module which is to be added onto that side of module 10 connect with each of the mating portions thereon.

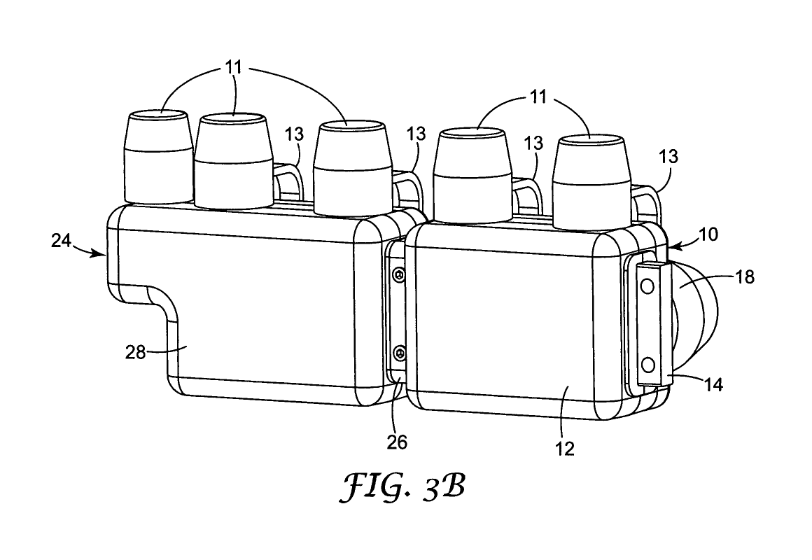

The expansion of module 10 into electrical connector 22 can be seen in FIG. 3A, which is a perspective view of five-port electrical connector 22 from the front and one side thereof. Electrical connector 22 is formed by connecting module 10 and base module 24 at joint 26. An electrical and mechanical connection is thereby formed between module 10 and base module 24. Alternate connecting mechanisms may not necessarily create joint 26 between module 10 and base 24, but modules 10 and 24 may directly abut one another. In FIG. 3A, module 10 is considered the “expansion” module, because it is added to base module 24, which only has an expansion capability off of one side. Both base module 24 and expansion module 10 may be formed of one or more modules connected together. The “base” and “expansion” module distinction is only made for clarity of explanation and preferably, there is no functional difference between the two types of modules in that both a base module and an expansion module mechanically and electrically connect with cables. Base module 24 includes body 28, female mating portion (not shown), ports 30, 32, and 34 (which have port seals 30A, 32A, and 34A, respectively), and bolt covers 11. Bolt covers 11 are each held onto module 24 by strap 13, where each strap 13 is connected to port seal 30A, 32A, and 34A, respectively. Modules 10 and 24 may be different sizes, and may have a different number of ports. Connecting two different sized modules may allow for development of a final multiport electrical connector which has ports that can accommodate different cable sizes, different cable constructions, or other variations.

Body 28 may be formed of any electrically conductive metal, such as aluminum or copper. The female mating portion (not shown in FIG. 3A) extends off a side of body 28. Ports 30, 32, and 34 are each configured to receive an electrical cable, where port 34 is configured to receive a different size cable than ports 30 and 32. Ports 30, 32, and 34 may also be the same size, or they may be different sizes. Ports 30, 32, and 34 are covered with port seal 30A, 32A, and 34A, respectively, where each seal is formed of an electrically insulating material, As shown, port seals 30A, 32A, and 34A are unplugged. However, as noted above, each port seal 30A, 32A, and 34A may be covered with a port plug, where the plug is formed of an electrically insulating material, such as EPDM. In FIG. 3A, port seal 16A is also unplugged (and thus ready to accept a cable therein) while port seal 18A has seal plug 19 therein, which may be removed at any time and replaced by a cable. The female mating portion of base module 24 is shaped similarly to female mating portion 20 of FIG. 2B, such that it mates with male mating portion 14 to form joint 26. Joint 26 can more clearly be seen in FIG. 3B, which is a rear perspective view of electrical connector 22 from the same side as FIG. 3A. If module 10 and module 24 each have more than one mating portion extending off the same side of body 12 and 28, more than one joint will be formed in place of joint 26 because more than one set of complimentary mating portions will connect between module 10 and module 24.

In general, after a joint (e.g., joint 26 of FIG. 3A and 3B) is formed between two modules, a securing mechanism, such as one or more set screws, may be used to urge and mechanically secure the joint (and thus, the modules) together. It is preferred that the joint is secured in order to help prevent the joint (and thus, the electrical connector) from becoming mechanically disconnected and to help maintain an electrical connection between the two modules.

After modules 10 and 24 are secured together, a generally continuous, electrically insulating coating may be formed on at least a part of electrical connector 22 (i.e., connected modules 10 and 24), as discussed in reference to body 12 in FIGS. 2A and 2B. Preferably, the coating is formed after electrical connector 22 is assembled at the manufacturing level, which occurs if no more modules are to be added onto electrical connector 22 by the manufacturer. A zip strip (e.g., zip strip 64 of FIG. 5A) may be positioned around male mating portion 14 prior to coating connected modules 10 and 24, if another module is not going to be connected to male mating portion 14. It is preferred that the coating is seamless, so the coating may help create a uniform electrical connector 22 which is perceived as a single unit rather than a plurality of individual modules connected together. An end user may add one or more expansion modules onto electrical connector 22 at a later time, even after the coating is formed over electrical connector 22. Of course, the electrical connector coating will not cover the module(s) that are added on by the end user, although those expansion modules may be separately coated.

It is preferred that a finished electrical connector 22 have at least one unattached mating portion (e.g., male mating portion 14) which an end user may use to expand the number of ports of electrical connector 22. An end user may add a single expansion module (e.g., module 10 of FIGS. 2A and 2B) or another electrical connector having at least two modules connected together and covered by a generally continuous, electrically insulative coating. The module or electrical connector may be added by connecting complimentary mating portions and securing the modules using a set screw mechanism and/or another securing mechanism. After the modules are secured together by an end user, the end user may wrap the resulting joint with a material which may protect the joint from environmental intrusions and to electrically mask any exposed conductive surface, such as with mastik tape. However, the end user is not required to wrap the resulting joint.

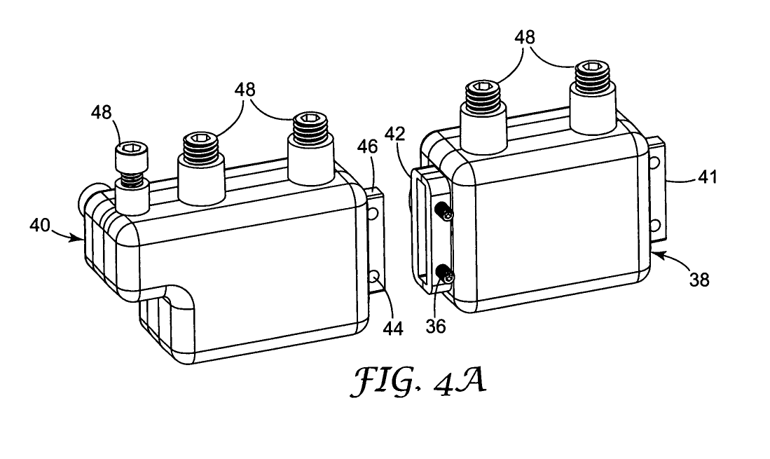

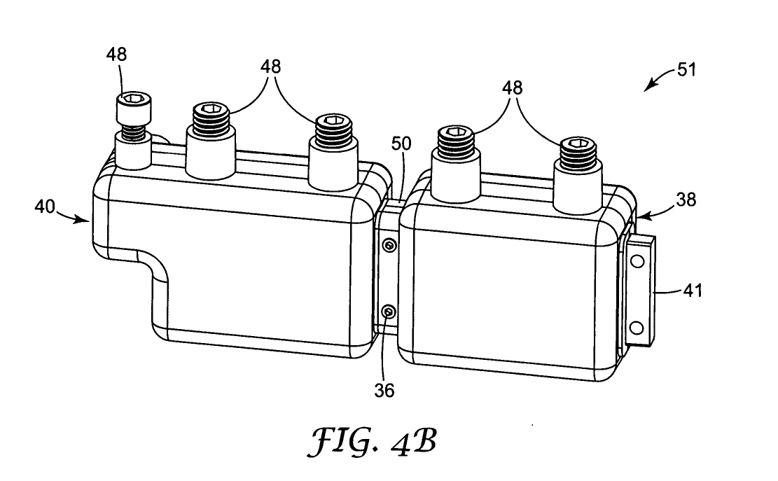

FIG. 4A is a rear perspective view, showing an exemplary embodiment of a securing mechanism that may be used between two modules. Set screws 36 are used to secure a joint formed between modules 38 and 40 (shown unconnected). FIG. 4A shows a rear view of modules 38 and 40, where the ports of each module 38 and 40 are located on a surface facing into the plane of the image. One or more set screws 36 are located on female mating portion 42 of module 38, and corresponding screw holes or recesses 44 are located on male mating portion 46 of module 40. Also shown in FIG. 4A are uncovered bolts 48.

FIG. 4B is a rear perspective view showing modules 38 and 40 after they have been electrically and mechanically connected at joint 50 and secured using set screws 36. It is preferred that a generally continuous, electrically insulative coating be formed over at least a part of electrical connector 51 after modules 38 and 40 are secured together. The coating may be formed over the assembled electrical connector 51 if no more modules are to be added onto electrical connector 51 at the manufacturing level, as discussed in reference to electrical connector in FIGS. 3A and 3B. However, if more modules are to be added at the same time modules 38 and 40 are connected, the coating should be formed after all the modules are added. It is also preferred that electrical connector 51 have at least one unattached mating portion (e.g., male mating portion 41 of module 38), which an end user may use to expand upon electrical connector 51.

FIG. 5A is a perspective view of module 52 showing the rear and side view of zip strip 64. Module 52 includes body 54, bolt caps 56, port 58, and zip strip 64. Although no overcoat is shown in FIG. 5A, an overcoat would be provided as preferably generally continuous over body 54. Body 54, bolt caps 56, and port 58 are similar to body 12, bolt caps 11, and ports 16 and 18 of module 10 of FIGS. 2A and 2B. Zip strip 64 is positioned around male mating portion 66 prior to forming the overcoat and preferably defines an outer perimeter of male mating portion 66. It is preferred that zip strip 64 is friction fitted around male mating portion 66 and further secured to body 54 by overcoat 60. However, an additional securing mechanism may be used to secure zip strip 64 to body 54. Preferably, zip strip 64 is sealably fitted around male mating portion 66 to prevent the overcoat material from forming underneath zip strip 64, which would otherwise make the section of the overcoat formed over male mating portion 66 difficult to remove.

FIG. 5B is a perspective view of zip strip 64. In this embodiment, zip strip 64 is a planar sheet that has an inner portion 64a and an outer portion 64b joined by a frangible seam 75 in order to define a separable section of the overcoat which covers over male mating portion 66 (shown in FIG. 5A) of the electrical connector, thus allowing that section to be removed to expose male mating portion 66. Zip strip 64 is preferably positioned to define a perimeter of male mating portion 66. Zip strip 64 may also be placed anywhere around the outside perimeter of male mating portion 66. As shown, zip strip has tab 65 attached to outer portion 64b, which may make it easier for a user to grip outer portion 64b to separate it from inner portion 64a along seam 75.

It is preferred that zip strip 64 is formed of a material that has sufficient flexibility to be formed around male mating portion 66, such as nylon. Zip strip 64 may also have a sharp edge in contact with the overcoat to help zip strip 64 cut through the overcoat. It is also preferred that zip strip 64 is formed of a material that is strong enough to break through the overcoat material and create a “clean” break, where a clean break occurs when zip strip 64 only cuts through the section of overcoat surrounding male mating portion 66 and does not remove portions of the overcoat which is covering the remainder of the module. It is preferred that the module remain as electrically insulated as possible, and so a clean break is preferred. It may be preferred to form the overcoat with a material and/or a thickness such that zip strip 64 does not prematurely break through the overcoat.

As shown in FIGS. 5A and 5B, it is preferred that tab 65 of zip strip 64 protrudes from body 54 and the coating (not shown in FIGS. 5A or 5B). An end user who wants to connect module 52 with another individual module or a module which is part of a finished electrical connector may grip or otherwise engage the protruding section and “pull” the zip strip to tear through the overcoat that is covering male mating portion 66, and separate this section of overcoat from male mating portion 66. The user may then remove the section of overcoat, thereby exposing male mating portion 66. Male mating portion 66 of module 52 may then be electrically and mechanically connected with a female mating portion of another module. Because male mating portion 66 was covered by a section of overcoat, the newly exposed male mating portion 66 will likely be a clean surface, which may enable a good electrical connection between the two modules being connected.

In this way, zip strip 64 may allow an end user to connect individual port modules together or add one or more modules onto a preassembled electrical connector in order to create any desired electrical connector configuration, rather than relying on a manufacturer to supply an electrical connector with the desired number of ports. Zip strip 64 may also be incorporated in other portions of module 52 that may require exposure after module 52 has left the manufacturing facility.

It is preferred that zip strip 64 is formed of a nonconductive material, such as nylon or polyethylene terephthalate (PET). In one embodiment, the zip strip may take the form of a strand provided under the overcoat, adjacent the mating portion to be exposed. For instance, materials such as dental floss, fishing line, or wire (formed from of a nonconductive material) may serve as the zip strip. Both nylon and PET are preferred materials for zip strip 64 because when an overcoat is formed over module 52 and zip strip 64 using the exemplary method described in reference to FIGS. 2A and 2B, neither nylon nor PET heat to as high of a temperature as the conductive material forming the body of module 52, thus reducing the preheat temperature of zip strip 64 as well as reducing the heat transfer when module 52 and zip strip 64 are dipped (or otherwise coated) into the protective material. The reduced temperature and heat transfer results in a thinner coating of overcoat material on zip strip 64. The thinner coating still serves as an effective electrical insulator, but facilitates the removal of zip strip 64 from the perimeter of male mating portion 66 because zip strip 64 has to tear through a thinner layer of the coating.

FIG. 5C is a sectional view as taken along line A-A in FIG. 5A, where overcoat 60 is formed over module 52. As seen in FIG. 5C, zip strip 64 extends around a perimeter of mating portion 66, which extends from body 54. For exemplary purposes, male mating portion 66 is shown as the entire section which extends from body 54. An overcoat 60 of coating material overlays body 54, mating portion 66, and zip strip 64. Preferably, zip strip 64 sits flush on outer surface 77 of body 54 and abuts side walls 79 of male mating portion 66 and body 54 so that coating material does not form between zip strip 64 and mating portion 66 and body 54, which would make it difficult to remove the section of overcoat 60a which overlays male mating portion 66. As mentioned above, in one embodiment zip strip 64 is formed of a material which does not heat to as high a temperature as body 54 during the coating process. As a result, overcoat 60 has a thickness of T₁ over mating portion 66 (and body 54) and a thickness of T₂ over zip strip 64, where T₁>T₂.

In the exemplary embodiment shown in FIG. 5A-5B, frangible seam 75 in zip strip 64 is formed from indentation 68 in zip strip 64, which allows separation of zip strip 64 into two pieces 64a and 64b, where one piece (64b) moves through overcoat 60 and the other piece (64a) remains under overcoat 60. The two pieces 64a and 64b are only partially divided because they remain partially connected at some point. The two pieces may allow easier removal of the section 60a of overcoat 60 which overlays male mating portion 66 because as the first piece 64b is pulled and lifted away from the electrical connector, the second piece 64a also lifts away from the electrical connector, which may then provide a lifting force from underneath overcoat 60.

FIG. 5D shows a second exemplary embodiment of zip strip 70, which is now positioned around male mating portion 66. Just as with zip strip 64, it is preferred that zip strip 70 sits flush on outer surface 77 of body 54 and abuts side walls 79 of male mating portion 66 and body 54. Overcoat 60 has a thickness of T₁ over mating portion 66 (and body 54) and a thickness of T₂ over zip strip 64, where T₁>T₂. Zip strip 70 has a smaller width than zip strip 64 of FIG. 5C, where a width is measured in a direction perpendicular to thickness To. Unlike zip strip 64, zip strip 70 does not have a frangible seam, and thus remains in one piece as it moves through overcoat 60. Zip strip 70 may move through overcoat 60 with less pressure on overcoat 60 than with zip strip 64 because a smaller area of overcoat 60 is removed. A thinner zip strip 70 may be preferred because an increased force over a decreased area may create a decreased pressure on overcoat 60. The decreased pressure may help zip strip 70 create a clean break in overcoat 60.

Although FIGS. 5C and 5D show a zip strip having a uniform width and thickness, both the width and thickness may vary within the zip strip. The tear strength of the zip strip may increase if the width and/or thickness of the zip strip gradually increases from the first portion of the zip strip which moves through the overcoat to the last portion of the zip strip which moves through the overcoat.

Although the present invention has been described with reference to exemplary embodiments, workers skilled in the art will recognize that changes may be made in form and detail without departing from the spirit and scope of the invention.

1. A method of forming an electrical connector, the method comprising:
electrically and mechanically connecting a first module to a second module; and
forming a generally continuous, electrically insulative coating over at least part of the connected first and second modules.

2. The method of claim 1, and further comprising:
securing the first module to the second module.

3. The method of claim 2, wherein the step of securing the first module to the second module comprises turning a threaded member.

4. The method of claim 1, wherein the coating is formed of a material selected from a group consisting of ethylene-propylene-diene monomer rubber and vinyl plastisol.

5. The method of claim 1, wherein the first and second modules each comprise:
a conductive body configured to receive an end of a cable;
a clamping member positioned within the body for making an electrical connection with the cable; and
a mating portion on the body.

6. The method of claim 5, wherein the first module has a male mating portion and the second module has a female mating portion, and wherein the connecting step comprises coupling the male mating portion with the female mating portion.

7. The method of claim 1, and further comprising:
masking portions of the first and second modules prior to forming the coating.

8. The method of claim 1, wherein after the first and second modules are connected, the second module has an exposed male mating portion, and wherein the method further comprises:
positioning a zip strip around the male mating portion to define an outer perimeter of the male mating portion prior to forming the coating, the zip strip being sealably mounted around the outer perimeter of the male mating portion.

9. The method of claim 8, and further comprising:
separating a section of the coating covering the male mating portion of the second module from the coating on the second module by pulling on the zip strip;
removing the section of the coating covering the male mating portion of the second module to expose the male mating portion; and
electrically and mechanically connecting a female mating portion of a third module to the male mating portion of the second module.

10. A method of expanding an electrical connector having an electrically insulative outer coating material thereon, the method comprising:
removing a section of the coating on the electrical connector which covers a first mating portion of the electrical connector by separating the coating along a frangible perimeter extending around the first mating portion;
electrically and mechanically connecting a second mating portion of an expansion module to the first mating portion of the electrical connector; and
securing the expansion module to the electrical connector.

11. The method of claim 10, wherein the step of securing the second module to the electrical connector comprises turning a threaded member.

12. The method of claim 10, wherein the electrical connector and second module each comprise:
a conductive body configured to receive an end of a cable; and
a clamping member positioned within the body for making an electrical connection with the cable.

13. The method of claim 10, wherein the frangible perimeter is defined by a zip strip.

14. An electrical connector module comprising:
a body;
a mating portion on the body;
a zip strip positioned on the body around the mating portion; and
an electrically insulative coating formed over the mating portion and the zip strip.

15. The connector module of claim 14, wherein a section of the zip strip protrudes from the coating.

16. The connector module of claim 14, wherein the zip strip is formed of a material selected from a group consisting of nylon and polyethylene terephthalate.

17. The connector module of claim 14, wherein the coating is formed of a material selected from a group consisting of ethylene-propylene-diene monomer rubber and vinyl plastisol.

18. An electrical connector assembly comprising:
a first module;
a second module connected to the first module, the second module having a mating portion extending from a side opposing the first module; and
an electrically insulative coating formed over at least part of the connected first and the second modules.

19. The electrical connector assembly of claim 18, and further comprising a zip strip positioned around the mating portion of the second module.

20. The electrical connector assembly of claim 19, wherein the electrically insulative coating is formed over the zip strip, and wherein a section of the zip strip protrudes from the coating.

21. The electrical connector assembly of claim 18, wherein the coating is formed of a material selected from a group consisting of ethylene-propylene-diene monomer rubber and vinyl plastisol.

22. The electrical connector assembly of claim 18, wherein the first and second modules each comprise:
a conductive body configured to receive an end of a cable; and
a clamping member positioned within the body for making an electrical connection with the cable.
